(19) United States
(12) Patent Application Publication
(10) Pub. No.: US 2018/0325772 A1
(43) Pub. Date: Nov. 15, 2018

(54) TRADITIONAL CHINESE MEDICINE TREATMENT DEVICE

(71) Applicant: GUILIN TONGTIAN KAITAI BIOLOGICAL TECHNOLOGY CO. LTD,, GUILIN (CN)

(72) Inventor: Xiaoqing LIU, GUILIN (CN)

(73) Assignee: GUILIN TONGTIAN KAITAI BIOLOGICAL TECHNOLOGY CO. LTD.

(21) Appl. No.: 16/044,493

(22) Filed: Jul. 24, 2018

Related U.S. Application Data
(63) Continuation of application No. PCT/CN2016/000069, filed on Feb. 2, 2016.

(30) Foreign Application Priority Data
Jan. 27, 2016 (CN) 201610054500.2

(51) Int. Cl. A61H 39/06; A61H 39/08; A61H 7/00

(52) U.S. Cl. CPC A61H 39/06; A61H 2201/105; A61H 7/00; A61H 39/086

(57) ABSTRACT

A traditional Chinese medicine treatment device comprises: a thermal compression purging module, a thermal compression tonifying module, a needle rotating module, an herb heating module. The thermal compression tonifying module generates an air stream and modulates the flow speed of the air stream. The thermal compression purging module generates a negative pressure and modulates the size of the negative pressure. The needle rotating module has a rotatable head. The herb heating module is used to heat an herb to provide the air stream generated by the thermal compression tonifying module with a small particle of the herb. A supporting application provided by the traditional Chinese medicine device makes a treatment process easier and faster to perform.

### CROSS-REFERENCE TO RELATED APPLICATIONS

This application is a continuation of International Patent Application No. PCT/CN2016/000069 with a filing date of Feb. 2, 2016, designating the United States, now pending, and further claims priority to Chinese Patent Application No. 201610054500.2 with a filing date of Jan. 27, 2016. The content of the aforementioned applications, including any intervening amendments thereto, are incorporated herein by reference.

### TECHNICAL FIELD

The disclosure relates to a medical device, and more particularly to a traditional Chinese medicine treatment device.

### BACKGROUND OF THE PRESENT INVENTION

In the traditional Chinese medical meridian therapy, manpower is the main force. The machines available are simple, such as the acupuncture, the scrapping plate, the cupping device, the acupoint pressing device, electric massage chair and so on, or artificial massage is used. However, there is neither dedicated device for traditional Chinese medicine treatment of meridian and acupoint, nor device for traditional Chinese medicine treatment cooperated with drugs, even no large general device for combining a variety of traditional Chinese medicine treatment methods.

The thermal compression tonifying treatment device available only make partial improvement on scrapping and thermal compression compared to conventional traditional Chinese medicine. However, general innovations on scrapping plate, scrapping device, moxibustion box, etc. haven't proposed yet. Especially, there is no breakthrough in the integration of tonifying and purging in traditional Chinese medicine. At the same time, the scrapping of the thermal compression tonifying treatment device is still manual instead of automatic.

Along with the trend of aging society and the development of traditional Chinese medicine treatment technology, more and more people prefer the traditional Chinese medical meridian therapy and its integral use. As a result, a comprehensive dedicated traditional Chinese medicine treatment device must be produced, which has a wide prospect of market.

### SUMMARY OF PRESENT INVENTION

The object of the disclosure is to provide a traditional Chinese medicine treatment device, in order to solve the problems of the complicated, time-waste, force-waste process and unconspicuous effect in traditional Chinese medicine treatment due to no systematic treatment device existed to combine several traditional Chinese medicine treatment.

The technical solutions adopted by the disclosure are as follows:

A traditional Chinese medicine treatment device is provided. A main body of the treatment device comprises one or several of the following components: a thermal compression purging module, a thermal compression tonifying module, a needle rotating module, an herb heating module. The thermal compression tonifying module generates an air stream and modulates the flow speed of the air stream. The thermal compression purging module generates a negative pressure and modulates the size of the negative pressure. The needle rotating module has a rotatable head. The herb heating module is used to heat a microelement or herb to provide the air stream generated by the thermal compression tonifying module with a small particle of the microelement or herb.

Advantageously, the thermal compression purging module comprises an airway tube of a thermal compression purging device and a thermal compression purging head provided on an end of the airway tube of the thermal compression purging device, and the thermal compression head adsorbs the body surface under a negative pressure; the thermal compression tonifying module comprises an airway tube of a thermal compression tonifying device and a thermal compression tonifying head provided on an end of the airway tube of the thermal compression tonifying device, and the air stream goes through the airway tube of the thermal compression tonifying device and erupts from the thermal compression tonifying head; the herb heating module comprises a hot flow generator and a herb container, and the hot flow generator heat the air stream from the thermal compression tonifying module to provide the air stream passing through the herb container with a small particle of the herb.

Advantageously, the main body of the treatment device is provided with one or several of the following components: a thermal compression purging control panel, a thermal compression tonifying control panel, a heating control panel and a needle rotating control panel. The thermal compression purging control panel is connected to a thermal compression purging control unit that is connected to a thermal compression purging motor, the thermal compression purging motor is connected to a negative pressure generator that is connected to the airway tube of the thermal compression purging device and an outlet of the thermal compression purging device. The size of the negative pressure produced by the negative pressure generator can be modulated through the thermal compression purging control panel. The thermal compression tonifying control panel is connected to a thermal compression tonifying control unit that is connected to a thermal compression tonifying motor, the thermal compression tonifying motor is connected to an air pump of the thermal compression tonifying device which is provided with the hot flow generator, the air pump of the thermal compression tonifying device is connected to the herb container that is connected to the airway tube of the thermal compression tonifying device, and the air pump of the thermal compression tonifying device is also connected to an inlet of the thermal compression tonifying device. The speed of the air stream of the air pump of the thermal compression tonifying device can be modulated through the thermal compression tonifying control panel. The heat control panel is connected to a heat control unit that is connected to the hot flow generator. The heat generated by the hot flow generator can be modulated through the heat control panel. The needle rotating control panel is connected to a needle rotating control unit that is connected to a rotating needle. The rotating speed of the rotating needle can be modulated through the needle rotating control panel.

Advantageously, the main body of the treatment device is provided with a pop-up rotating power switch which is capable of bouncing to switch on an external power when it is rotated and capable of switching off the external power when it is pushed.

In the disclosure, the compound air stream (energy stream, particle stream, information stream) including atomized Chinese herb is led out by the thermal compression tonifying head of the thermal compression tonifying device, then it acts on the human skin and meridian. Meanwhile, the opening side of the thermal compression tonifying head can be pressed on the skin and pushed towards the meridian to achieve the effects of pulse-flow thermal compression tonifying and herb-gas scrapping. The thermal compression purging device, corresponding to the thermal compression tonifying device, is absorbed on the acupoint and the meridian of human skin through the thermal compression purging head, and make the opening of the thermal compression purging head flat press the skin, push and pull towards the skin meridian, therefore achieving the effects such as air conditioning thermal compression purging, negative-pressure cupping, deflation and detoxification, and so on. The thermal compression tonifying device and the thermal compression purging device directly reflect the tonifying function and purging function of traditional Chinese medicine, which overcome the disadvantages of conventional thermal compression meridian treatment device with single tonifying function. The rotating scrapping head is put towards the human skin and acupoint and rotated with a certain speed by a motor, thus achieving the innovative function of electrically automatic scrapping.

The beneficial effect of the disclosure can be achieved since the supplementary application of the traditional Chinese medicine treatment device, which make the treatment process more simple and efficient, and combine the conventional traditional Chinese medicine message treatment, traditional Chinese medicine treatment device, traditional Chinese medicine herb treatment, etc. together to obtain a conspicuous effect.

### DESCRIPTION OF THE DRAWINGS

FIG. 1 is a structural schematic diagram of a traditional Chinese medicine treatment device;

FIG. 2 is a structural diagram of the internal circuit modules in the traditional Chinese medicine treatment device;

FIG. 3 is a schematic diagram of an herb container according to the third embodiment;

FIG. 4 is a side view of an herb container according to the fourth embodiment:

FIG. 5 is a schematic diagram of an internal herb storage device in the herb container according to the fourth embodiment;

FIG. 6 is a schematic diagram of a thermal compression purging module;

FIG. 7 is a schematic diagram of a thermal compression tonifying module;

FIG. 8 is a schematic diagram of a rotating needle;

FIG. 9 is a schematic diagram of a long needle;

FIG. 10 is a schematic diagram of a plain needle;

FIG. 11 is a schematic diagram of a short needle.

In the figures:
1 a housing
2 a thermal compression purging control panel
3 a thermal compression tonifying control panel
4 a heat control panel
5 a needle rotating control panel
6 a connecting hole of the airway tube of the thermal compression purging device
7 a connecting hole of the airway tube of the thermal compression tonifying device
8 a needle rotating power socket
9 a thermal compression purging head
10 a first clip
11 a thermal compression tonifying head
12 a second clip
13 a rotating needle
14 a third clip
15 a rotating power switch
16 a road wheel device
17 a main switch
18 a hot flow generator
19 a shell of the herb container
20 a connector of the gas pump of the thermal compression tonifying device
21 a connector of the airway tube of the thermal compression tonifying device
22 a herb storage device
23 a mesh surface
24 a herb drop inlet
25 a negative pressure generator
26 an airway tube of the thermal compression purging device
27 a thermal compression purging head
28 a through-hole
29 a thermal compression tonifying head
30 an airway tube of the thermal compression tonifying device
31 a screw cap
32 an outlet
33 a head of the rotating needle
34 a shell of the rotating needle
35 a retarding mechanism
36 a motor of the rotating needle
37 a ringed bulge
38 an aperture
39 a small dome
40 a cambered bulge
201 a thermal compression purging control unit
202 a thermal compression purging motor
301 a thermal compression tonifying control unit
302 a thermal compression tonifying motor
401 a heat control unit
501 a needle rotating control unit DETAILED DESCRIPTION OF PREFERRED EMBODIMENTS

The present disclosure will be illustrated in detail with reference to the accompanying drawings and embodiments below.

### EMBODIMENT 1

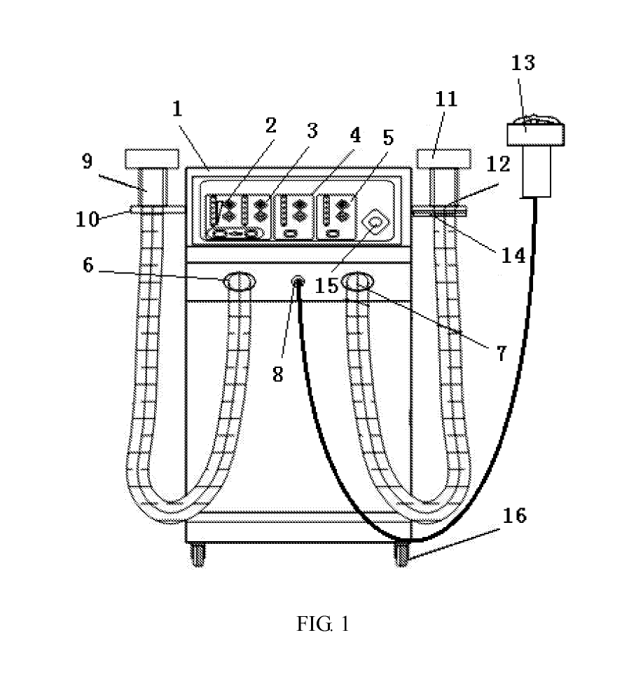

Referring to FIG. 1, a traditional Chinese medicine treatment device is shown. The front face at the top of the housing 1 is provided with a thermal compression purging control panel 2, a thermal compression tonifying control panel 3, a heat control panel 4, and a needle rotating control panel 5. The front face at the middle of the housing 1 is provided with a connecting hole of the airway tube of the thermal compression purging device 6, a connecting hole of the airway tube of the thermal compression tonifying device 7, and a needle rotating power socket 8. A thermal compression purging head 9 is removably provided on a first clip 10 on the side face at the top of the housing 1, and a thermal compression tonifying head 11 is removably provided on a second clip 12. A rotating needle 13, which is provided on a third clip 14 on the side face at the top of the housing 1, is connected to the needle rotating power socket 8 through a power line. The front face at the top of the housing 1 is also provided with a rotating power switch 15, and the bottom of the housing 1 is provided with a road wheel device 16.

### EMBODIMENT 2

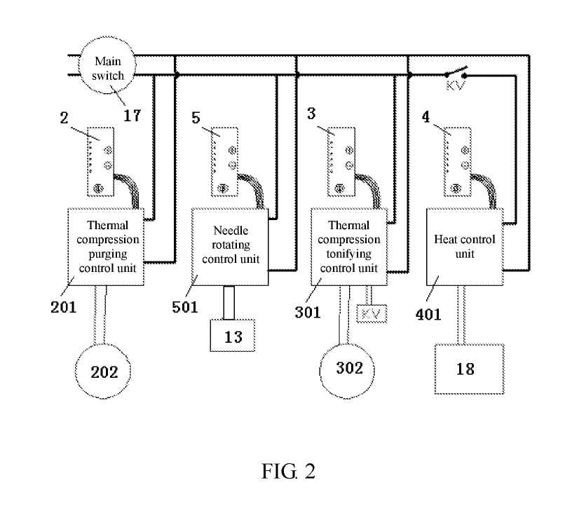

FIG. 2 is a schematic diagram of the circuital connection of the control module in the traditional Chinese medicine treatment device. Referring to FIG. 2, the thermal compression purging control panel 2 is connected to a thermal compression purging control unit 201 that is connected to a thermal compression purging motor 202. The thermal compression tonifying control panel 3 is connected to a thermal compression tonifying control unit 301 that is connected to a thermal compression tonifying motor 302. The heat control panel 4 is connected to a heat control unit 401 that is connected to a hot flow generator 18. The needle rotating control panel 5 is connected to a needle rotating control unit 501. The main switch 17 is respectively connected to and used to control the powers of the thermal compression purging control panel 2, the thermal compression tonifying control panel 3, the heat control panel 4 and the needle rotating control panel 5.

### EMBODIMENT 3

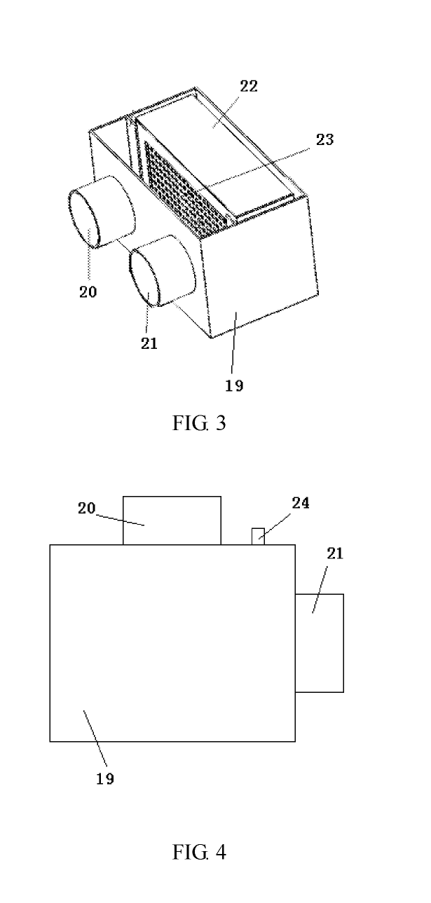

FIG. 3 is a schematic diagram of an herb container. Referring to FIG. 3, a connector of the gas pump of the thermal compression tonifying device 20 and a connector of the airway tube of the thermal compression tonifying device 21 are provided on a same face of the shell of the herb container 19. A removable herb storage device 22 for storing the herb is provided in the shell of the herb container 19. One face of the herb storage device 22 is a transparent mesh surface 23 that faces the connector of the gas pump of the thermal compression tonifying device 20 and the connector of the airway tube of the thermal compression tonifying device 21. The air pump of the thermal compression tonifying device is connected to the shell of the herb container 19, for pushing the hot air stream heated by the hot flow generator 18 into the shell of the herb container 19, and thus micronizing the herb in the herb storage device 22 by the hot air. Then, the hot air stream with the small particles of the herb enters the airway tube of the thermal compression tonifying device and erupts out from the thermal compression tonifying head 11 in order to act on the surface of human body. The thermal compression tonifying head 11 goes towards the human meridian, so the air stream with the small particles of the herb acts on the human meridian to achieve the effect of meridian medicine massage.

### EMBODIMENT 4

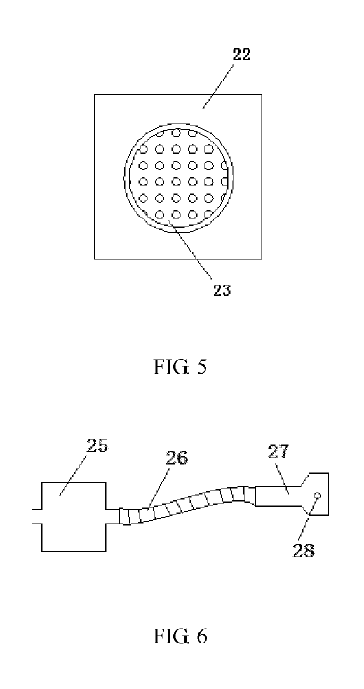

Referring to FIGS. 4 and 5, another herb container of the present invention is provided. A connector of the gas pump of the thermal compression tonifying device 20 and a connector of the airway tube of the thermal compression tonifying device 21 are provided on adjacent faces of the shell of the herb container 19. A herb drop inlet 24 for receiving herb drops is provided near to the connector of the gas pump of the thermal compression tonifying device 20 on the shell of the herb container 19. A herb storage device 22 for storing the herb is provided in the shell of the herb container 19. One face of the herb storage device 22 is a transparent mesh surface 23 that faces the connector of the gas pump of the thermal compression tonifying device 20 and the herb drop inlet 24. Using this kind of herb container, not only the solid herb can be put in the herb storage device 22, but also the prepared liquid herb can be dropped in in the process to be gasified, so that the herb message treatment can be made to certain meridian.

### EMBODIMENT 5

Referring to FIG. 6, a thermal compression purging module comprises a negative pressure generator 25, an airway tube of the thermal compression purging device 26 and a thermal compression purging head 27. The negative pressure generator 25 and the thermal compression purging head 27 form an air channel through the hollow airway tube of the thermal compression purging device 26. The front end of the thermal compression purging head 27 is flat, and a through-hole 28 is provided on its head. The negative pressure generator 25 produces continuous negative-pressure suction to make the thermal compression purging head 27 absorbed on the acupoint and the meridian of human skin, and make the opening of the thermal compression purging head flat press the skin, push and pull towards the skin meridian, therefore achieving the effects such as air conditioning thermal compression purging, negative-pressure cupping, deflation and detoxification, and so on.

### EMBODIMENT 6

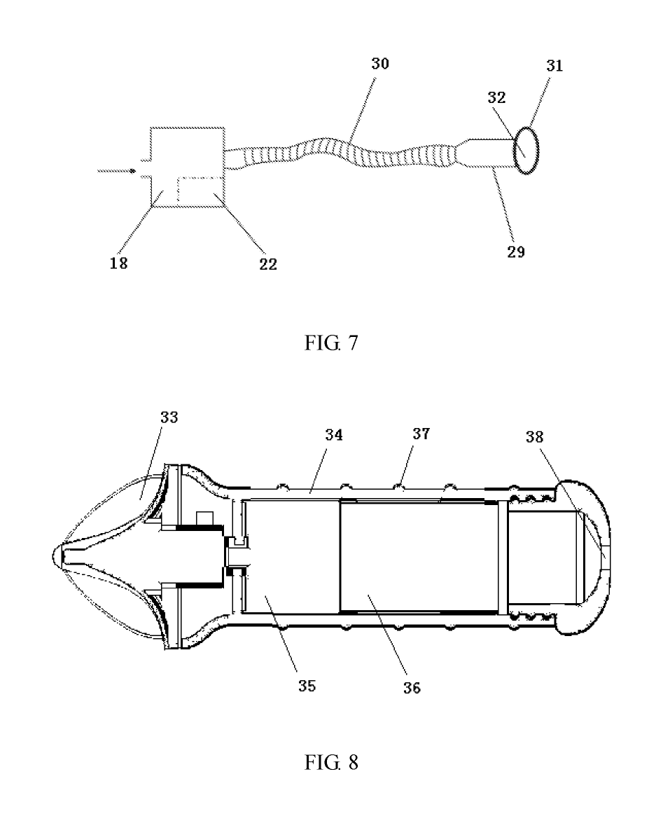

Referring to FIG. 7, a thermal compression tonifying module comprises a thermal compression tonifying head 29, an airway tube of the thermal compression tonifying device 30 and a hot flow generator 18. The thermal compression tonifying head 29 is connected with the hot flow generator 18 through the airway tube of the thermal compression tonifying device 30, forming an air outlet hollow channel from head to end. The herb storage device 22 is provided in the hot flow generator 18 that produces a positive-pressure hot air stream to atomize the herb with microelements in the herb storage device 22. Then the atomized herb is blew out through the airway tube of the thermal compression tonifying device 30 and the thermal compression tonifying head 29. The thermal compression tonifying head 29 consists of a hollow perimeter wall and a screw cap 31 at the front end which also serves as a scrapping head. And an outlet 32 is provided at the center of the screw cap 31. The compound air stream (energy stream, particle stream, information stream) including microelements and atomized Chinese herb is led through the tube and out of the outlet on the screw cap 31, then it acts on the human skin and meridian. In the meanwhile, the screw cap 31 can be pressed on the skin and pushed towards the meridian to achieve the effects of pulse-flow thermal compression tonifying and herb-gas scrapping.

### EMBODIMENT 7

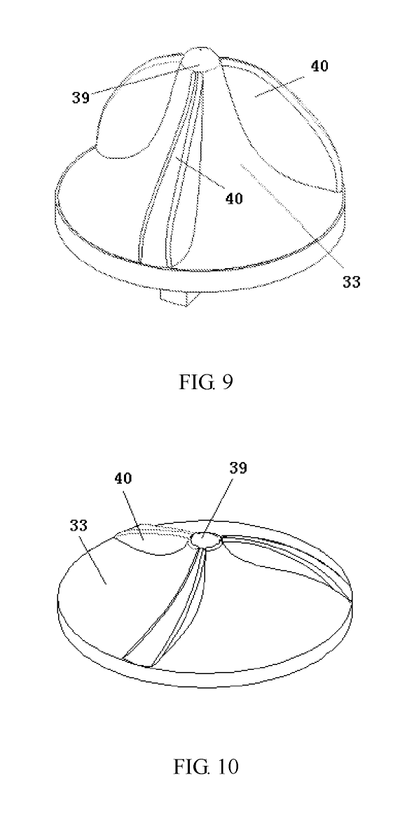

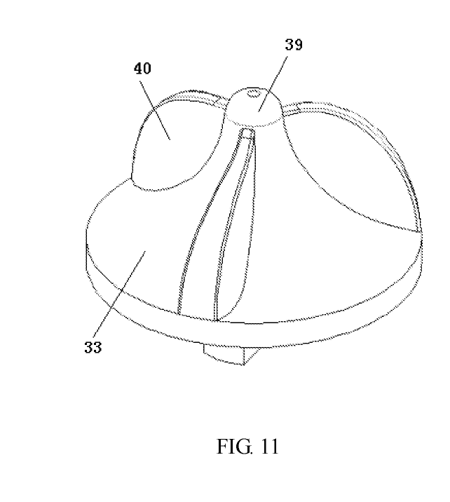

Referring to FIG. 8, a rotating needle of the present invention comprises a rotating needle head 33, and the tip of the rotating needle head 33 is placed outwards at one end of a shell of the rotating needle 34. A retarding mechanism 35 and a motor of the rotating needle 36 are provided in the shell of the rotating needle 34. The rear of the rotating needle head 33 is connected to the retarding mechanism 35 that is connected to the motor of the rotating needle 36. The shell of the rotating needle 34 is cylindrical, the outside of which is provided with a ringed bulge 37. The rear of the shell of the rotating needle 34 is removably connected to the other end of the shell of the rotating needle 34 through a screwed connection. A aperture 38 for passing through power lines is provided at the rear of the shell of the rotating needle. Referring to FIGS. 9-1, the rotating needle head 33 is a cone, the side face of which is a concave curved shape, the top of which is a small dome 39. Three cambered bulges 40 spaced equally are provided on the side face of the cone, and their ends are between the top and bottom of the cone. A short needle, a flat needle or a long needle can be used as the rotating needle head based on the height of the cone. While using, the rotating needle head 33 touches the skin acupoint and is rotated with a certain speed by a control-handle-rotating-machine-barrel needle rotating motor. Then the vortex with a magnetic force is acted on the acupoint, which can effectively open the closed acupoint and adjust relevant functions of body and organs.

The other advantages of the traditional Chinese medicine treatment device of the disclosure are as follows. It is an integration of several traditional Chinese medicine treatment functions. And it is an innovative general treatment device of traditional Chinese medicine, which is improved based on modern machinery and electric technology. It combines innovative functions, such as pulse-current thermal compression tonifying, herb-gas scrapping, pumped cupping, dredging meridian and so on, through 3 functional generators in the thermal compression meridian treatment device, namely the thermal compression tonifying device, the rotating scrapping device (i.e. rotating needle) and the thermal compression purging device. Therefore, it can directly and effectively achieve the object of purging and tonifying, dredging meridian, balancing the two opposing principles in nature.

The above is only the preferred embodiments of the disclosure, but not the limitations. Any modification, equivalent, and improvement made within the spirit and principle of the disclosure will fall into the scope of the disclosure.

I claim:

1. A traditional Chinese medicine treatment device, wherein, a main body of the treatment device comprises:
a thermal compression purging module configured to generate a negative pressure and modulates the size of the negative pressure,
a thermal compression tonifying module configured to generate an air stream and modulates the flow speed of the air stream;
a needle rotating module with a rotatable head, and
an herb heating module configured to heat a microelement or herb to provide the air stream generated by the thermal compression tonifying module with a small particle of the microelement or herb.

2. The traditional Chinese medicine treatment device of claim 1, wherein, the thermal compression purging module comprises an airway tube of a thermal compression purging device and a thermal compression purging head provided on an end of the airway tube of the thermal compression purging device, and the thermal compression head adsorbs the body surface under a negative pressure; the thermal compression tonifying module comprises an airway tube of a thermal compression tonifying device and a thermal compression tonifying head provided on an end of the airway tube of the thermal compression tonifying device, and the air stream goes through the airway tube of the thermal compression tonifying device and erupts from the thermal compression tonifying head; the herb heating module comprises a hot flow generator and a herb container, and the hot flow generator heat the air stream from the thermal compression tonifying module to provide the air stream passing through the herb container with a small particle of the herb.

3. The traditional Chinese medicine treatment device of claim 2, wherein, the main body of the treatment device is provided with one or several of the following components: a thermal compression purging control panel, a thermal compression tonifying control panel, a heating control panel and a needle rotating control panel;
the thermal compression purging control panel is connected to a thermal compression purging control unit that is connected to a thermal compression purging motor, and the thermal compression purging motor is connected to a negative pressure generator that is connected to the airway tube of the thermal compression purging device and an outlet of the thermal compression purging device;
the thermal compression tonifying control panel is connected to a thermal compression tonifying control unit that is connected to a thermal compression tonifying motor, the thermal compression tonifying motor is connected to an air pump of the thermal compression tonifying device which is provided with the hot flow generator, the air pump of the thermal compression tonifying device is connected to the herb container that is connected to the airway tube of the thermal compression tonifying device, and the air pump of the thermal compression tonifying device is also connected to an inlet of the thermal compression tonifying device;
the heat control panel is connected to a heat control unit that is connected to the hot flow generator, and
the needle rotating control panel is connected to a needle rotating control unit that is connected to a rotating needle.

4. The traditional Chinese medicine treatment device of claim 2, wherein, the main body of the treatment device is provided with a pop-up rotating power switch which is capable of bouncing to switch on an external power when rotated and capable of switching off the external power when pushed.
